(19) United States
(12) Patent Application Publication
(10) Pub. No.: US 2013/0322653 A1
(43) Pub. Date: Dec. 5, 2013

(54) USB AUDIO DEVICE

(71) Applicants: TSAI Yu-Fen, New Taipei City (TW); Chang Jung-Chin, New Taipei City (TW); Tu Randy, New Taipei City (TW); Lin Shar-Ming, New Taipei City (TW)

(72) Inventors: TSAI Yu-Fen, New Taipei City (TW); Chang Jung-Chin, New Taipei City (TW); Tu Randy, New Taipei City (TW); Lin Shar-Ming, New Taipei City (TW)

(73) Assignee: FORMOSA21 Inc., New Taipei City (TW)

(21) Appl. No.: 13/564,216

(22) Filed: Aug. 1, 2012

(30) Foreign Application Priority Data
May 30, 2012 (TW) 101210306

(51) Int. Cl. H04R 3/00

(52) U.S. Cl. 381/111

(57) ABSTRACT

A USB audio device includes a USB connector for connection to a general purpose computer, a USB controller connected to the USB connector for receiving an digitized audio signal from the computer and transmitting a digitized microphone signal and a controlling signal to the computer system, a digital/analog converter connected to the USB controller for processing the audio signal and the microphone signal and an earset socket connected to the digital/analog converter and having a left signal contact, a right signal contact, a ground contact, and a microphone signal contact.

### BACKGROUND OF THE INVENTION

1. Field of the Invention

The present invention is related to a USB audio device capable of connecting 4-pole TRRS earset to a general purpose computer, and more particularly to a USB audio device with a digital/analog converter to link the general purpose computer and a 4-pole earset for a hand held electronic device.

2. Description of Related Art

Following the trend of modern technology, hand held electronic devices are becoming more and more advanced and users of these hand held electronic devices are growing each day. Among all these hand held electronic devices, smart phones, flat computers and the like are the most popular electronic devices. Walking on the streets, a scene one can never miss is that you can always expect to see people talking over the mobile phone or browsing the internet via the mobile devices. As these devices are limited in size, almost every hand held electronic device adopts sockets for 4-pole TRRS (tip, ring, ring, sleeve) earsets such that users may always use TRRS earset to listen to the music stored in the hand held electronic devices.

These earsets each has a 4-pole plug that includes a left signal contact, a right signal contact, a ground contact, and a microphone signal contact such that the music in the electronic devices can be transmitted to the users stereophonically. In the meantime, voices from the user may be transmitted to the hand held electronic devices via the microphone as well as the microphone signal contact. In addition, these earsets all seem to have control buttons to control the volume of the sound, pause, play or next selection functions. Users of such earset can also receive incoming calls. As a result of these convenient functions, the 4-pole TRRS earset is becoming a standard equipment attached to the package when the hand held device is sold.

Now reviewing back to a general purpose computer, it is seen that almost all general purpose computers adopt two separate earset 3.5 mm sockets, one for earphone and another for the microphone. That is, whenever the user wants to listen to the music or conduct a conversation via the computer, the user may have to prepare an independent earset for the two earset plugs. However, if the user wants to use the 4-pole TRRS earset for connection with the computer, the user may need to have an adapter to adapt the 4-pole TRRS earset plug for connection to the two 3.5 mm sockets. Preparing such an adapter and connecting the TRRS earset to the adapter are too troublesome. Besides, the button functions on the TRRS earset can no longer be functional once the adapter is adopted.

In order to solve the problem(s), the present invention introduces a USB audio device to allow the user to directly connect to the TRRS earset plug without any adapter and maintain the function buttons on the TRRS earset functional.

### SUMMARY OF THE INVENTION

The primary objective of the present invention is to provide a USB audio device which is able to connect the general purpose computer to the 4-pole TRRS earset.

In order to accomplish the above objective, the USB audio device constructed in accordance with the present invention includes:

a USB connector for connection to a general purpose computer;

a USB controller connected to the USB connector for receiving an audio signal from the computer and transmitting a microphone signal and a controlling signal to the computer system;

a digital/analog converter connected to the USB controller for processing the audio signal and the microphone signal; and

an earset socket connected to the digital/analog converter and having a left signal contact, a right signal contact, a ground contact, and a microphone signal contact.

In a preferred embodiment, the microphone signal contact is connected to the USB controller.

In still another embodiment, the earset socket is a 3.5 mm standard socket.

In yet another embodiment, the earset socket is a TRRS socket.

With the help of the USB audio device of the present invention, the user may connect a 4-pole TRRS earset to the computer so as to provide an earphone, microphone and a functional selection.

### BRIEF DESCRIPTION OF THE DRAWINGS

FIG. 1 is a block diagram showing the structure of the USB audio device of the present invention;

FIG. 2 is a perspective view showing the USB audio device of the present invention;

FIG. 3 is a schematic view showing the application of the USB audio device with the computer and the TRRS earset;

FIG. 4 is still a schematic view showing that the USB audio device of the present invention is able to receive audio signal and transmit microphone signal as well as controlling signal.

### DETAILED DESCRIPTION OF THE INVENTION

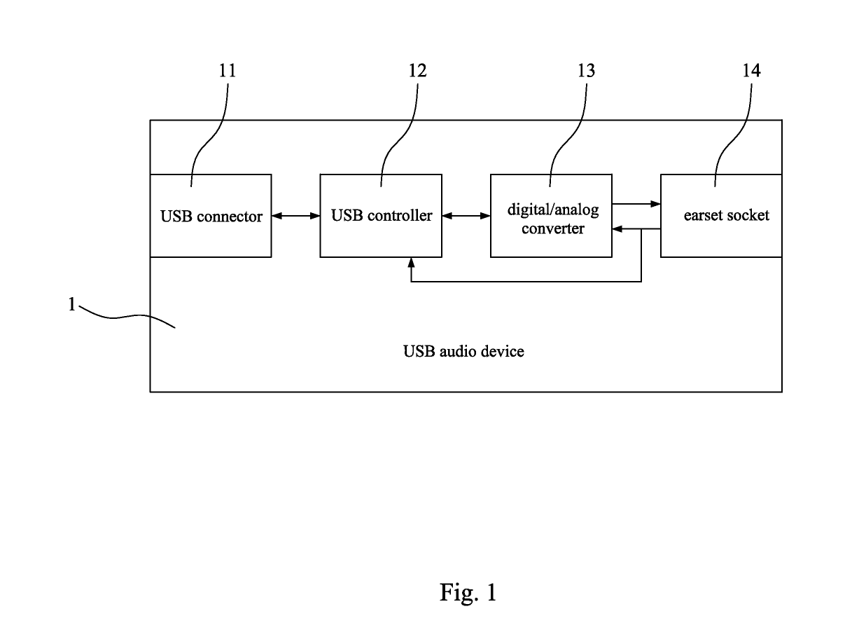

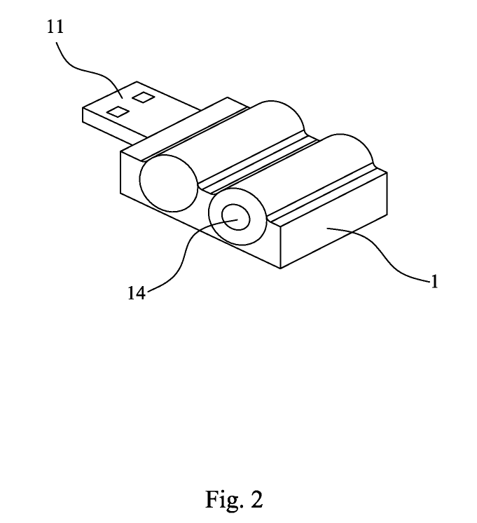

With reference to FIGS. 1 to 2, it is noted from the preferred embodiment of the present invention that the USB audio device 1 so constructed has a USB connector 11, a USB controller 12, a digital/analog converter 13 and an earset socket 14.

The USB connector 11 is used for connection to a general purpose computer and is a standard USB male connector (a terminal). The shape and function of such a connector is well known in the art. The general purpose computer may be a laptop computer, a flat computer or a desktop computer. The general purpose computer used in the preferred embodiment of the present invention is a laptop computer.

The USB controller 12 is connected to the USB connector for receiving a digitized audio signal from the computer and transmitting a microphone signal and a controlling signal to the computer system. In practice, the USB controller 12 receives digital information from the computer and separates a digitized audio signal from the information. The separated digitized audio signal is then sent out for further purpose.

The digital/analog converter 13 is connected to the USB controller 12 to process the audio signal and the microphone signal. In practice, the digital/analog converter 13 receives the digitized audio signal from the USB controller 12 and converts such digitized audio signal into an analog signal and then sends it out for further purpose.

The earset socket 14 is connected to the digital/analog converter 13 and has a left signal contact, a right signal contact, a ground contact, and a microphone signal contact. In practice, the analog audio signal is sent to the left signal contact and the right signal contact. The microphone signal contact is used to connect to the microphone of the earset for hand held electronic devices to receive microphone signals from such a microphone. Then the digital/analog converter 13 converts the analog microphone signal into a digital signal that is recognizable by the computer system. The USB controller 12 is thus able to transmit the digitized microphone signal to the computer system 2. The earset socket 14 is a 3.5 mm 4-pole standard audio socket and is a TRRS socket, which is compatible to the earsets widely used in the currently available smart phones.

It is noted that the microphone signal contact may also be used as a transmitting media for controlling signals. The controlling signals may be a digital signal or an analog signal. When the controlling signal is a digital signal, it is not necessary to go through the conversion process so that when the microphone signal contact is used as the transmitting media for the controlling signal, the microphone signal contact is directly connected to the USB controller 12. When the controlling signal is an analog signal, the digital/analog converter 13 converts such signal into a corresponding digital signal and then the converted digital signal is sent to the USB controller 12. Either way, the two types of controlling signals are respectively transmitted to the computer system by the USB controller 12 via the USB connector 11.

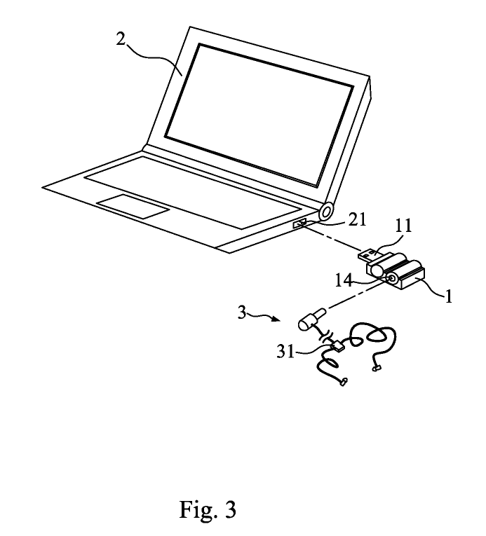

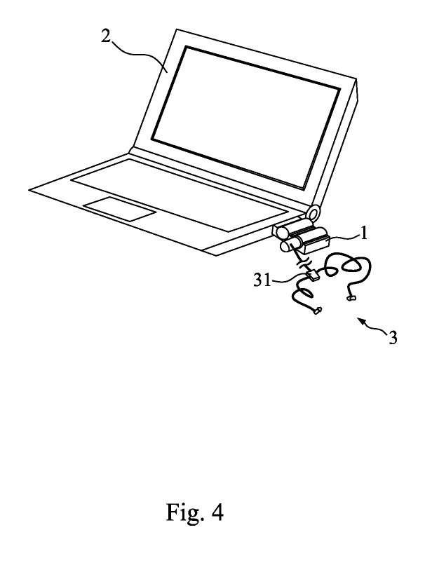

With reference to FIGS. 3 and 4, it is noted that the USB audio device 1 of the present invention includes a USB connector 11. The USB connector 11 is connected to the USB connection socket 21 on the computer system 2.

After the USB audio device 1 of the present invention is connected to the USB connection socket 21 of the computer system 2, the user may insert the plug of an earset 3 into the earset socket 14 to allow the user to talk over the microphone and to listen over the earphone.

Furthermore, it is seen that the earset 3 has multiple function buttons 31 allowing the user to use the function buttons 31 to achieve whatever functions available. The earset 3 has a microphone contact on its 4-pole TRRS 3.5 mm plug and the digital/analog converter 13 provides 0.2 v voltage necessary for the microphone contact of earset 3. Therefore, one way to transmit controlling signals to the computer system 2 is to ground this microphone contact. For example, the user may press one of the function buttons 31 once or twice. Each press on the function button, a pulse is sent to the USB controller 12 to pick up. And when the USB controller 12 picks up one or two pulses, a corresponding command is then sent to the computer system 2.

From the above description, it is noted that the present invention has the following advantages, such as:

1. The USB audio device is compatible to the 4-pole TRRS earsets used by the smart phones available on the market so as to allow the generally available TRRS earset to communicate with the computer system. As a result, there is no need for the user to change any of his/her habits using the TRRS earset and can still connect to the computer system 2.

2. Through the USB audio device, the user may adjust the volume, pause, play or select playing next song or even talk by adjusting the function buttons 31 on the earset 3.

While the invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A USB audio device comprising:
a USB connector for connection to a general purpose computer;
a USB controller connected to the USB connector for receiving an audio signal from the computer and transmitting a microphone signal and a controlling signal to the computer system;
a digital/analog converter connected to the USB controller for processing the audio signal and the microphone signal; and
an earset socket connected to the digital/analog converter and having a left signal contact, a right signal contact, a ground contact, and a microphone signal contact.

2. The USB audio device as claimed in claim 1, wherein the microphone signal contact is connected to the USB controller.

3. The USB audio device as claimed in claim 1, wherein the earset socket is a 3.5 mm 4-pole standard socket.

4. The USB audio device as claimed in claim 1, wherein the earset socket is a TRRS socket.
